(19) United States
(12) Patent Application Publication
(10) Pub. No.: US 2012/0068099 A1
(43) Pub. Date: Mar. 22, 2012

(54) TWO-PART VALVE

(75) Inventor: Mark Sealy, Warwickshire (GB)

(73) Assignee: Norgren Limited, Staffordshire (GB)

(21) Appl. No.: 13/321,922

(22) PCT Filed: Jun. 11, 2010
(86) PCT No.: PCT/GB10/01157

§ 371 Date: Nov. 22, 2011

(30) Foreign Application Priority Data
Jun. 11, 2009 (GB) 0910082.7

(51) Int. Cl. F16K 31/00

(52) U.S. Cl. 251/291

(57) ABSTRACT

A two-part valve (100) is provided according to the invention. The two-part valve (100) includes a valve body (104) including a valve mechanism (103), with the valve mechanism (103) including an actuation member (107), a valve flange (105) formed on the valve body (104), a valve actuator (123) configured to couple to the valve body (104), with the valve actuator (123) including an actuator shaft (126) configured to couple to the actuation member (107) of the valve mechanism (103), an actuator flange (124) formed on the valve actuator (123), and a clamp configured to clamp the actuator flange (124) to the valve flange (105), thereby removably affixing the valve actuator (123) to the valve body (104).

### BACKGROUND OF THE INVENTION

1. Field of the Invention

The invention is related to the field of valves, and more particularly, to a two-part valve.

2. DESCRIPTION OF THE PRIOR ART

Valves are used in a variety of applications, including in industrial environments, vehicles, buildings and structures, etc. A valve is typically a one-piece unit comprising a valve mechanism and an integral actuator portion.

The prior art approaches a valve as a unit and provides a combined actuator and mechanism. Alternatively, the prior art provides an actuator and valve mechanism that are joined by fasteners, such as where both units include flanges that are bolted together to form a complete valve. However, where the actuator and valve mechanism are made from different materials, they may need to be separated for servicing.

Prior art valve generally do not permit disassembly. The prior art valves that can be disassembled are not designed to be disassembled in an efficient and straightforward manner.

### ASPECTS OF THE INVENTION

In some aspects of the invention, a two-part valve comprises:
a valve body including a valve mechanism, with the valve mechanism including an actuation member;
a valve flange formed on the valve body;
a valve actuator configured to couple to the valve body, with the valve actuator including an actuator shaft configured to couple to the actuation member of the valve mechanism;
an actuator flange formed on the valve actuator; and
a clamp configured to clamp the actuator flange to the valve flange, thereby removably affixing the valve actuator to the valve body.

Preferably, the valve actuator can be rotationally positioned with respect to the valve body.

Preferably, an interior shape of the clamp forces together the valve flange and the actuator flange.

Preferably, the valve flange and the actuator flange are substantially circular.

Preferably, the valve flange and the actuator flange are non-circular.

Preferably, the two-part valve further comprises one or more alignment features located on either the valve flange or the actuator flange, with the one or more alignment features creating one or more rotational alignment positions.

Preferably, the clamp includes one or more tightening devices operable to constrict the clamp to the valve flange and the actuator flange.

Preferably, the clamp and the actuator shaft are substantially coaxial.

Preferably, the clamp, the actuator shaft, and the actuation member of the valve mechanism are substantially coaxial.

Preferably, the actuator shaft is configured to at least partially rotate.

Preferably, the actuator shaft is configured to at least partially translate.

In some aspects of the invention, a two-part valve comprises:
a valve body including a valve mechanism, with the valve mechanism including an actuation member;
a valve flange formed on the valve body;
a valve actuator configured to couple to the valve body, with the valve actuator including an actuator shaft configured to couple to the actuation member of the valve mechanism;
an actuator flange formed on the valve actuator;
a clamp configured to clamp the actuator flange to the valve flange, thereby removably affixing the valve actuator to the valve body; and
one or more alignment features located on either the valve flange or the actuator flange, with the one or more alignment features creating one or more rotational alignment positions.

Preferably, the valve actuator can be rotationally positioned with respect to the valve body.

Preferably, an interior shape of the clamp forces together the valve flange and the actuator flange.

Preferably, the valve flange and the actuator flange are substantially circular.

Preferably, the valve flange and the actuator flange are non-circular.

Preferably, the clamp includes one or more tightening devices operable to constrict the clamp to the valve flange and the actuator flange.

Preferably, the clamp and the actuator shaft are substantially coaxial.

Preferably, the clamp, the actuator shaft, and the actuation member of the valve mechanism are substantially coaxial.

Preferably, the actuator shaft is configured to at least partially rotate.

Preferably, the actuator shaft is configured to at least partially translate.

In some aspects of the invention, a two-part valve comprises:
a valve body including a valve mechanism, with the valve mechanism including an actuation member;
a valve flange formed on the valve body;
a valve actuator configured to couple to the valve body, with the valve actuator including an actuator shaft configured to couple to the actuation member of the valve mechanism;
an actuator flange formed on the valve actuator, with the valve flange and the actuator flange being substantially circular; and
a clamp configured to clamp the actuator flange to the valve flange, thereby removably affixing the valve actuator to the valve body, wherein the clamp and the actuator shaft are substantially coaxial.

Preferably, the valve actuator can be rotationally positioned with respect to the valve body.

Preferably, an interior shape of the clamp forces together the valve flange and the actuator flange.

Preferably, the two-part valve further comprises one or more alignment features located on either the valve flange or the actuator flange, with the one or more alignment features creating one or more rotational alignment positions.

Preferably, the clamp includes one or more tightening devices operable to constrict the clamp to the valve flange and the actuator flange.

Preferably, the clamp, the actuator shaft, and the actuation member of the valve mechanism are substantially coaxial.

Preferably, the actuator shaft is configured to at least partially rotate.

Preferably, the actuator shaft is configured to at least partially translate.

### BRIEF DESCRIPTION OF THE DRAWINGS

The same reference number represents the same element on all drawings. It should be understood that the drawings are not necessarily to scale.

FIG. 1 shows a two-part valve according to the invention.

FIG. 2 shows detail of the two-part valve according to the invention.

FIG. 3 shows the two-part valve according to the invention.

### DETAILED DESCRIPTION OF THE INVENTION

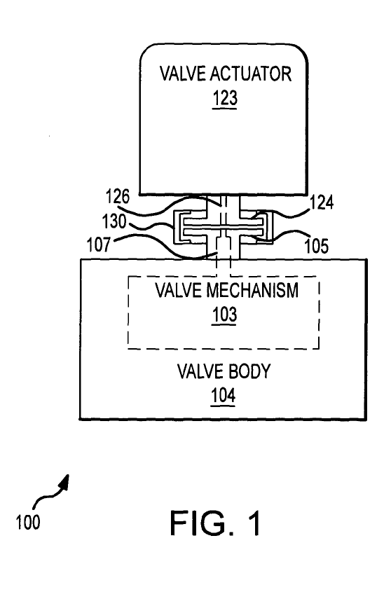

FIGS. 1-3 and the following description depict specific examples to teach those skilled in the art how to make and use the best mode of the invention. For the purpose of teaching inventive principles, some conventional aspects have been simplified or omitted. Those skilled in the art will appreciate variations from these examples that fall within the scope of the invention. Those skilled in the art will appreciate that the features described below can be combined in various ways to form multiple variations of the invention. As a result, the invention is not limited to the specific examples described below, but only by the claims and their equivalents.

FIG. 1 shows a two-part valve 100 according to the invention. The two-part valve 100 comprises a valve actuator 123 in combination with a valve body 104. The valve actuator 123 can be removably affixed to the valve body 104 by a clamp 130.

Advantageously, the two-part valve 100 therefore comprises two main components that can be assembled together to form the valve 100. The two-part valve 100 is removably affixed together and can be disassembled as needed.

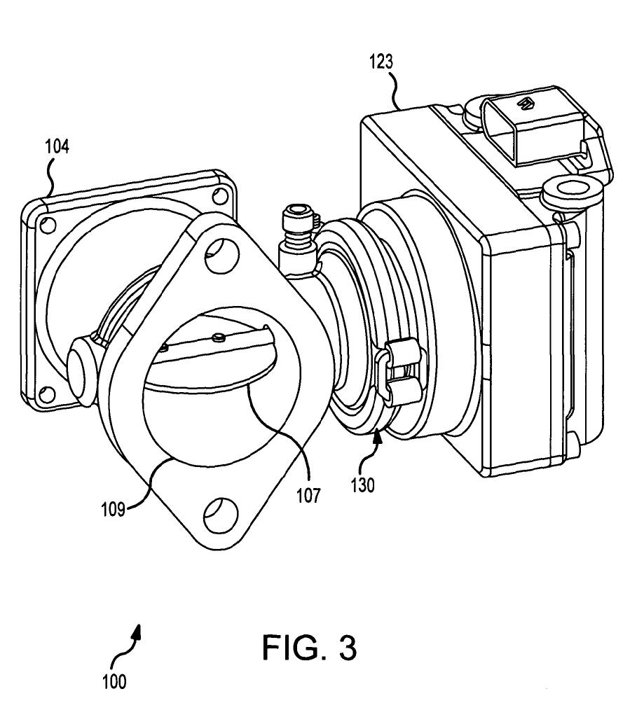

The valve body 104 includes a valve mechanism 103, an actuation member 107 connected to the valve mechanism 103, and a valve flange 105 formed on the valve body 104. The valve actuator 123 includes an actuator shaft 126 configured to couple to the actuation member 107 of the valve mechanism 103, and an actuator flange 124 formed on the valve actuator 123. The valve flange 105 and the actuator flange 124 are configured to be placed together and can extend from their respective components. Further, the valve actuator 123 can include a throat through which an actuator shaft 126 extends and the valve body 104 likewise includes a throat 105 (see FIG. 3) through which an actuation member 107 extends. The two-part valve 100 further comprises a clamp configured to clamp the valve flange 105 to the actuator flange 124, thereby removably affixing the valve actuator 123 to the valve body 104.

When assembled, the valve actuator 123 is placed to the valve body 104 so that the valve flange 105 and the actuator flange 124 are substantially together. The clamp 130 is placed over the valve flange 105 and the actuator flange 124 and is then constricted. Constriction of the clamp 130 clamps together the valve flange 105 and the actuator flange 124 and removably affixes the valve actuator 123 to the valve body 104. When assembled, the clamp 130 and the actuator shaft 126 are substantially coaxial. Further, the clamp 130, the actuator shaft 126, and the actuation member 107 of the valve mechanism 103 are substantially coaxial.

An advantage of the two-part valve 100 is that the valve actuator 123 is rotationally adjustable with respect to the valve body 104. Consequently, the valve actuator 123 can be placed in a desired rotational position with respect to the valve body 104 and then the clamp 130 can be constricted, fixing the valve actuator 123 in place.

It can be seen from the figure that the valve actuator 123 includes an actuator shaft 126 and the valve mechanism 103 includes an actuation member 107. One or both of the actuator shaft 126 and the actuation member 107 can include some manner of coupling feature that can engage and couple the actuator shaft 126 with the actuation member 107, as shown in the figure. As a result, when the valve actuator 123 is affixed to the valve body 104, the actuator shaft 126 will engage the actuation member 107 and the valve actuator 123 can subsequently actuate the valve mechanism 103.

The valve actuator 123 can comprise any actuator mechanism. The valve actuator 123 can comprise a mechanical actuator, electrical actuator, pneumatic actuator, hydraulic actuator, etc. Other actuator types are contemplated and are within the scope of the description and claims.

The valve mechanism 103 can comprise any manner of suitable mechanism. For example, the valve mechanism 103 can comprise a butterfly valve mechanism, ball valve mechanism, poppet valve mechanism, spool valve mechanism, gate valve mechanism, or any other valve mechanism that can be actuated via the actuation member 107. Consequently, the actuation motion transferred from the valve actuator 123 in some embodiments comprises a partial or full rotation. In other embodiments, the actuation motion comprises a partial or full translation motion. The translation can include a substantially axial translation. The translation can include swinging, pivoting, or other non-axial translations. It should be understood that other valve mechanisms and actuations are contemplated and are within the scope of the description and claims.

The valve flange 105 and the actuator flange 124 can be of any shape or size. The valve flange 105 and the actuator flange 124 can substantially correspond in shape and size, but do not have to do so.

In some embodiments, the valve flange 105 and the actuator flange 124 are substantially circular. As a result, the valve actuator 123 can rotate with respect to the valve body 104 when the two flanges are not securely clamped together. Alternatively, the valve flange 105 and the actuator flange 124 can comprise other, non-circular shapes, such as shapes that limit the position of the valve actuator 123 with respect to the valve body 104. For example, the valve flange 105 and the actuator flange 124 can be substantially octagonal, wherein the valve actuator 123 can be assembled to one of eight positions with respect to the valve body 104.

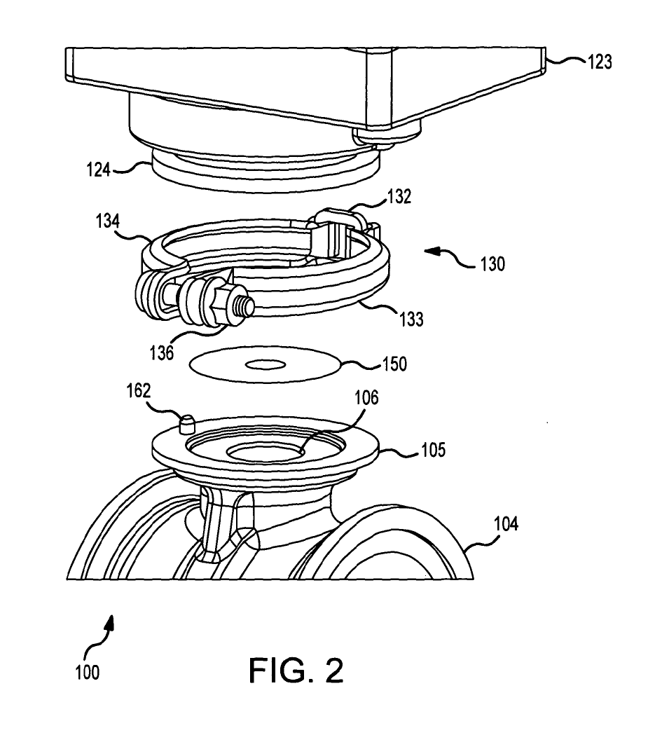

The clamp 130 can comprise any suitable clamp. The clamp 130 is configured to enclose the valve flange 105 and the actuator flange 124 and constrict and clamp together these two components. An interior shape of the clamp 130 substantially corresponds to the valve flange 105 and the actuator flange 124 and forces the two flanges together when suitably constricted. Therefore, the clamp 130 includes one or more tightening devices 136 operable to constrict and tighten the clamp (see FIG. 2). The one or more tightening devices 136 can be designed to be hand manipulated or can require a tool or tools.

In some embodiments, the clamp 130 comprises a V-clamp including two angled interior surfaces that form a V-shape. The V-clamp 130 is therefore constructed to force the two flanges together when the V-clamp 130 is substantially constricted.

The clamp 130 in some embodiments comprises an independent component, as shown in the various figures. Alternatively, the clamp 130 can be removably or permanently affixed to one of the valve actuator 123 or the valve body 104. In another alternative, the clamp 130 can comprise a portion of one of the valve actuator 123 or the valve body 104.

FIG. 2 shows detail of the two-part valve 100 according to the invention. This figure shows the valve flange 105 and the corresponding valve throat 106, the actuator flange 124, and a spacer 150 that is received and trapped between the two main components.

The spacer 150 can seal between the two components. To that end, the spacer 150 can be at least partially resilient and/or partially compressible. The spacer 150 can be of a thickness wherein the valve flange 105 and the actuator flange 124 must at least partially compress the spacer 150 before the two flanges come into contact. Alternatively, the joint can be vented or may not need to be fluid tight.

The spacer 150 can comprise a friction element that at least partially prevents rotation of the two valve components when clamped between the two flanges. The friction characteristic can be provided by the resilient/compressible nature of the spacer 150, for example.

The figure shows detail of an embodiment of the clamp 130. In this embodiment, the clamp 130 comprises first and second clamp portions 133 and 134. In another embodiment, the clamp 130 can comprise a single piece with one split, wherein only a single tightening device 136 is needed. A joiner mechanism 132 joins the two clamp portions at one point and a tightening device 136 joins the other ends. The joiner mechanism 132 can comprise a mechanical arrangement, including a disengageable mechanism, such as the buckle and loops shown (see also FIG. 3). However, other mechanisms are contemplated and are within the scope of the description and claims. For example, the clamp 130 can be constructed with two tightening devices 136.

The tightening device 136 can be manipulated to constrict the clamp 130, as previously discussed. Therefore the tightening device 136 can bring together ends of the first and second clamp portions 133 and 134. In the embodiment shown, the tightening device 136 comprises a threaded fastener. The threaded fastener can comprise a nut and bolt, but can comprise other configurations, such as a threaded screw that engages an aperture (or threaded aperture) in a clamp portion end.

As previously discussed, the internal shape of the clamp 130 acts to force together the two flanges. The internal shape can therefore be substantially rectangular, with perpendicular sidewalls. Alternatively, the sidewalls can be angled, curved, or of other desired shapes.

The figure further shows an alignment feature 162 extending from the valve flange 105. The alignment feature 162 can be of any shape or size. The alignment feature 162 in some embodiments comprises a dowel. The alignment feature 162 engages a substantially corresponding aperture, notch, depression, et cetera (not shown) in the actuation flange 124. The alignment feature 162 can therefore align the valve actuator 123 with the valve body 104 during assembly. Advantageously, the alignment feature 162 in some embodiments may assist in aligning the actuator shaft 126 with the actuation member 107 of the valve mechanism 103. Further, the alignment feature 162 can prevent rotation of the valve actuator 123 with respect to the valve body 104.

Only one alignment feature 162 is shown, but it should be understood that the two-part valve 100 can include multiple such alignment features. Further, the location of the alignment feature 162 on the valve flange 105 of the valve body 104 is not required, and the alignment feature 162 and any corresponding apertures can be swapped in location. Moreover, even if only one alignment feature 162 is provided, the opposing flange can include multiple apertures. As a result, multiple rotational positions can be available during assembly.

FIG. 3 shows the two-part valve 100 according to the invention. The actuation member 107 in this embodiment comprises a butterfly valve that is rotated within a valve chamber 109. Consequently, the rotational orientation of the valve actuator 123 may be important or even critical in order to achieve a desired rotational actuation of the actuation member 107. The valve body 104 can include flanges or other features that enable the two-part valve 100 to be assembled to other components or devices.

The various embodiments of the invention can be implemented to provide several advantages, if desired. The two-part valve can be easily assembled and employs a simple attachment mechanism. The two-part valve in some embodiments can be hand assembled and hand disassembled. The two-part valve can be easily disassembled for inspection, servicing, or replacement. The two-part valve offers infinite rotational positioning. The two-part valve works well in high vibration or high thermal cycling environments. The two-part valve needs a smaller mounting area, reducing any heat transfer between parts and offers a smaller overall size. The rotational capability of the two-part valve allows installation flexibility, wherein if the actuator is not uniform in size/shape, the installation may be at a predetermined orientation in order to accommodate other structures.

We claim:

1. A two-part valve (100), comprising:
a valve body (104) including a valve mechanism (103), with the valve mechanism (103) including an actuation member (107);
a valve flange (105) formed on the valve body (104);
a valve actuator (123) configured to couple to the valve body (104), with the valve actuator (123) including an actuator shaft (126) configured to couple to the actuation member (107) of the valve mechanism (103);
an actuator flange (124) formed on the valve actuator (123); and
a clamp configured to clamp the actuator flange (124) to the valve flange (105), thereby removably affixing the valve actuator (123) to the valve body (104).

2. The two-part valve (100) of claim 1, wherein the valve actuator (123) can be rotationally positioned with respect to the valve body (104).

3. The two-part valve (100) of claim 1, with an interior shape of the clamp (130) forcing together the valve flange (105) and the actuator flange (124).

4. The two-part valve (100) of claim 1, with the valve flange (105) and the actuator flange (124) being substantially circular.

5. The two-part valve (100) of claim 1, with the valve flange (105) and the actuator flange (124) being non-circular.

6. The two-part valve (100) of claim 1, further comprising one or more alignment features (162) located on either the valve flange (105) or the actuator flange (124), with the one or more alignment features (162) creating one or more rotational alignment positions.

7. The two-part valve (100) of claim 1, wherein the clamp (130) includes one or more tightening devices (136) operable to constrict the clamp (130) to the valve flange (105) and the actuator flange (124).

8. The two-part valve (100) of claim 1, wherein the clamp (130) and the actuator shaft (126) are substantially coaxial.

9. The two-part valve (100) of claim 1, wherein the clamp (130), the actuator shaft (126), and the actuation member (107) of the valve mechanism (103) are substantially coaxial.

10. The two-part valve (100) of claim 1, wherein the actuator shaft (126) is configured to at least partially rotate.

11. The two-part valve (100) of claim 1, wherein the actuator shaft (126) is configured to at least partially translate.

12. A two-part valve (100), comprising:
a valve body (104) including a valve mechanism (103), with the valve mechanism (103) including an actuation member (107);
a valve flange (105) formed on the valve body (104);
a valve actuator (123) configured to couple to the valve body (104), with the valve actuator (123) including an actuator shaft (126) configured to couple to the actuation member (107) of the valve mechanism (103);
an actuator flange (124) formed on the valve actuator (123);
a clamp configured to clamp the actuator flange (124) to the valve flange (105), thereby removably affixing the valve actuator (123) to the valve body (104); and
one or more alignment features (162) located on either the valve flange (105) or the actuator flange (124), with the one or more alignment features (162) creating one or more rotational alignment positions.

13. The two-part valve (100) of claim 12, wherein the valve actuator (123) can be rotationally positioned with respect to the valve body (104).

14. The two-part valve (100) of claim 12, with an interior shape of the clamp (130) forcing together the valve flange (105) and the actuator flange (124).

15. The two-part valve (100) of claim 12, with the valve flange (105) and the actuator flange (124) being substantially circular.

16. The two-part valve (100) of claim 12, with the valve flange (105) and the actuator flange (124) being non-circular.

17. The two-part valve (100) of claim 12, wherein the clamp (130) includes one or more tightening devices (136) operable to constrict the clamp (130) to the valve flange (105) and the actuator flange (124).

18. The two-part valve (100) of claim 12, wherein the clamp (130) and the actuator shaft (126) are substantially coaxial.

19. The two-part valve (100) of claim 12, wherein the clamp (130), the actuator shaft (126), and the actuation member (107) of the valve mechanism (103) are substantially coaxial.

20. The two-part valve (100) of claim 12, wherein the actuator shaft (126) is configured to at least partially rotate.

21. The two-part valve (100) of claim 12, wherein the actuator shaft (126) is configured to at least partially translate.

22. A two-part valve (100), comprising:
a valve body (104) including a valve mechanism (103), with the valve mechanism (103) including an actuation member (107);
a valve flange (105) formed on the valve body (104);
a valve actuator (123) configured to couple to the valve body (104), with the valve actuator (123) including an actuator shaft (126) configured to couple to the actuation member (107) of the valve mechanism (103);
an actuator flange (124) formed on the valve actuator (123), with the valve flange (105) and the actuator flange (124) being substantially circular; and
a clamp configured to clamp the actuator flange (124) to the valve flange (105), thereby removably affixing the valve actuator (123) to the valve body (104), wherein the clamp (130) and the actuator shaft (126) are substantially coaxial.

23. The two-part valve (100) of claim 22, wherein the valve actuator (123) can be rotationally positioned with respect to the valve body (104).

24. The two-part valve (100) of claim 22, with an interior shape of the clamp (130) forcing together the valve flange (105) and the actuator flange (124).

25. The two-part valve (100) of claim 22, further comprising one or more alignment features (162) located on either the valve flange (105) or the actuator flange (124), with the one or more alignment features (162) creating one or more rotational alignment positions.

26. The two-part valve (100) of claim 22, wherein the clamp (130) includes one or more tightening devices (136) operable to constrict the clamp (130) to the valve flange (105) and the actuator flange (124).

27. The two-part valve (100) of claim 22, wherein the clamp (130), the actuator shaft (126), and the actuation member (107) of the valve mechanism (103) are substantially coaxial.

28. The two-part valve (100) of claim 22, wherein the actuator shaft (126) is configured to at least partially rotate.

29. The two-part valve (100) of claim 22, wherein the actuator shaft (126) is configured to at least partially translate.
